(19) United States
(12) Patent Application Publication
(10) Pub. No.: US 2012/0188851 A1
(43) Pub. Date: Jul. 26, 2012

(54) Electronic apparatus, timepiece device, pedometer, and program

(76) Inventor: Keisuke Tsubata, Chiba-shi (JP)

(21) Appl. No.: 13/374,872

(22) Filed: Jan. 19, 2012

(30) Foreign Application Priority Data
Jan. 20, 2011 (JP) 2011-010071

(51) Int. Cl. G04B 47/00; G04F 10/00

(52) U.S. Cl. 368/10; 368/108; 368/109

(57) ABSTRACT

Provided is a timepiece device that includes a time measurement portion which measures a time, wherein, when a measured time passes a predetermined target time, and when information indicating that there is an input from a user is input, the time measurement portion sets the time to zero and restarts the measurement of the time.

### BACKGROUND OF THE INVENTION

1. Field of the Invention

The present invention relates to an electronic apparatus, a timepiece device, a pedometer, and a program.

2. Background Art

In stopwatches, a stopwatch that is equipped with a timer (a target timer) which starts a countdown of a predetermined target time (a target time) together with a start and, when the remaining time is reaches zero, notifies the user is known. A stopwatch equipped with the target timer is used, for example, as below in marathons, athletics or the like. When distance displays from a start point are present, for example, for each km, a target time of a section spent for running 1 km is stored in the target timer. After the countdown is started, when the remaining time shown by the countdown timer becomes zero, the stopwatch notifies a user that the target time has elapsed using a sound notification or the like. If the distance display is present in the 1 km point, when passing therethrough, a user presses a lap button and restarts the target timer from there. After that, the stopwatch notifies again a user through the sound notification or the like, after the target time elapses. As a result, a user can know whether or not the time distribution of the running of each section is appropriate.

JP-UM-B-06-28718 describes that, when a first target time is input in a stopwatch, the value of an integral multiplication of the first target time is automatically set as a second target time thereafter.

JP-A-09-72973 describes that a target time of a previous section is displayed as an initial value during the setting operation of the next lap time in a stopwatch.

However, for example, when the distance display of 1 km point is missed and it is difficult to press the lap button, the target timer is not restarted until the lap operation is performed at the 2 km point after the notification is performed near 1 km. Thus, until the lap operation is performed at the 2 km point, the target timer does not function. That is, there was a problem in that it is difficult for a user to know the next target time in a case where the lap button is not depressed.

### SUMMARY OF THE INVENTION

It is an aspect of the present application to provide an electronic apparatus, an electronic timepiece, a pedometer, and a program that notify the passage of the target time even when depressing of the lap button is not performed.

(1) According to another aspect of the present application, there is provided a timepiece device that includes a time measurement portion which measures a time, wherein, when a measured time passes a predetermined target time, and when information indicating that there is an input from a user is input, the time measurement portion sets the time to zero and restarts the measurement of the time.

(2) Furthermore, according to another aspect of the present application, the time measurement portion may include a control portion that performs a control of notifying a user that the measured time has passed the target time.

(3) Furthermore, according to another aspect of the present application, the control portion may perform a control which notifies elapsed time information that indicates the time measured from the elapsed time when the measured time has passed the target time, and a control which notifies a user of remaining time information indicating that the time measured from the time when information is input has passed the target time indicates a remaining time until passing the target time, when information indicating that there is an input from a user is input.

(4) Furthermore, according to another aspect of the present application, when the measured time has passed the target time and passes the predetermined time, the control portion may display the remaining time information.

(5) Furthermore, according to another aspect of the present application, when the measured time has passed the target time and a running distance measured by a pedometer measurement portion reaches the predetermined distance, the control portion may display the remaining time information.

(6) Furthermore, according to another aspect of the present application, an electronic apparatus is provided that includes the timepiece device mentioned above.

(7) Furthermore, according to still another aspect of the present application, a pedometer is provided that includes the timepiece device mentioned above.

(8) Furthermore, according to still another aspect of the present application, there is provided a program for causing a computer of the timepiece device to execute a sequence of setting the time to zero and starting the measurement of time when the measured time passes a predetermined target time and when information indicating that there is an input from a user is input.

According to the aspects of the present application, even when a user does not press the lap button, it is possible to notify a user of a passage of target time.

### BRIEF DESCRIPTION OF THE DRAWINGS

FIG. 1 is an exterior diagram that shows an exterior of a stopwatch according to a first embodiment of the present invention.

FIG. 2 is a schematic block diagram that shows a configuration of the stopwatch according to the present embodiment.

FIG. 3 is a functional block diagram of a CPU in the stopwatch according to the present embodiment.

FIG. 4 is a diagram that shows an example of a relationship between a motion in the stopwatch according to the present embodiment and an operation of a user.

FIG. 5 is a flowchart that shows an example of the motion in the stopwatch according to the present embodiment.

FIG. 6 is a diagram that shows an example of a display in the stopwatch according to the present embodiment.

FIG. 7 is a schematic block diagram that shows a configuration of the stopwatch according to a second embodiment of the present invention.

FIG. 8 is a functional block diagram of a CPU in the stopwatch according to the present embodiment.

FIG. 9 is a flowchart that shows an example of a motion in the stopwatch according to the present embodiment.

### DETAILED DESCRIPTION OF THE INVENTION

### First Embodiment

Hereinafter, a first embodiment of the present invention will be described with reference to the drawings.

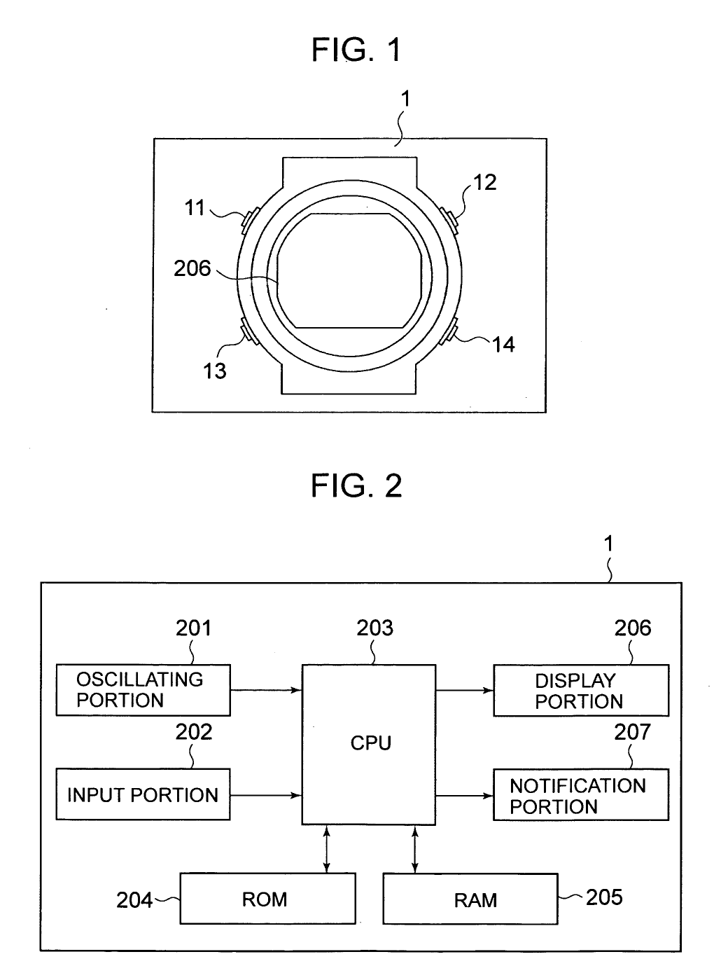

FIG. 1 is an exterior diagram that shows an exterior of a stopwatch 1 (a timepiece device) according to an embodiment of the present invention. In the example shown, the stopwatch 1 includes buttons 11 to 14, and a display portion 206.

A button 11 is used for the input of a start, a stop and a reset of the timekeeping from a user.

A button 12 is used for the input of information indicating a passage of a lap point from the user.

A button 13 is used for the input of a change in display mode from a user.

A button 14 is used for the input of changes in operation mode (a stopwatch mode, a normal timepiece mode, a timer mode, a world timepiece mode or the like) from a user.

Furthermore, a combination of the buttons 11 to 14 is also used for the input of a running target time (a target time) between the lap points.

A display portion 206 is formed from a display element such as a liquid crystal panel, and displays a measured time, setting information for each mode, or the like.

FIG. 2 is a schematic block diagram that shows a configuration of the stopwatch 1 (an electronic apparatus) according to a first embodiment of the present invention. In the example shown, the stopwatch 1 includes an oscillation portion 201, an input portion 202, a CPU (Central Processing Unit) 203, a Read Only Memory (ROM) 204, a Random Access Memory (RAM) 205, a display portion 206, and a notification portion 207.

The oscillation portion 201 divides the signal that is output from an oscillating element such as a crystal vibrator, and creates and outputs a clock signal with a frequency suitable for the operation of the CPU 203.

The input portion 202 includes buttons 11 to 14, and receives the input from the outside. For example, when a user performs the start, the stop, the lap, the target time setting, the operation mode, or the switching of the screen display of the stopwatch, a user inputs the command by the use of buttons 11 to 14 provided in the timepiece. The input portion 202 outputs the signal depending on the input to the CPU 203. For example, when the button 12 is depressed, the input portion 202 outputs the signal indicating the passage of the lap point to the CPU 203.

The CPU 203 performs various process operations in synchronization with the clock signal that is output from the oscillation portion 201. For example, the CPU 203 performs processes as below. Information is input from the input portion 202 into the CPU 203. The CPU 203 reads the program from the ROM 204. The CPU 203 writes the data to the RAM 205. The CPU 203 reads data from the RAM 205. The CPU 203 displays the measured time, the setting information of each mode or the like on the display portion 206.

Data other than the program is written to the ROM 204. These are read from the CPU 203 as necessary.

The RAM 205 holds the data that needs to be temporarily preserved.

The notification portion 207 notifies the user that a predetermined time has been reached through a sound notification, a vibration or the like.

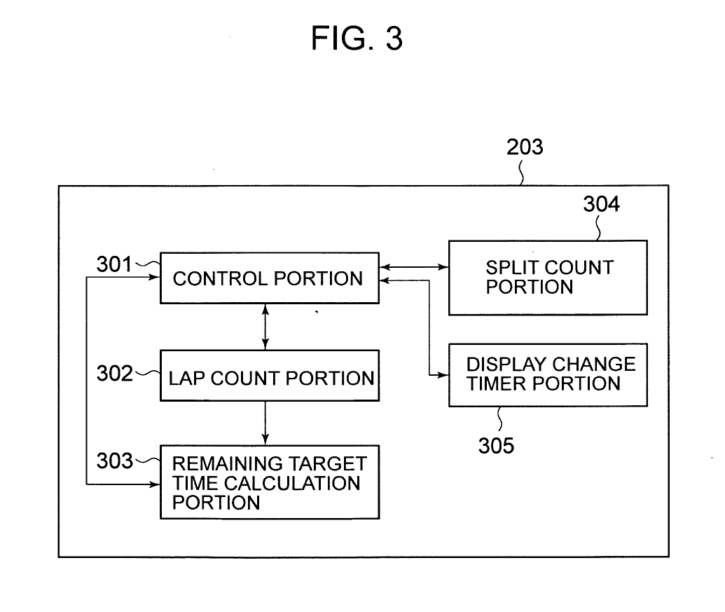

FIG. 3 is a schematic block diagram that shows configurations of each portion that performs the process in the inner portion of the CPU 203. In the example shown, a control portion 301, a lap count portion 302, a remaining target time calculation portion 303, a split count portion 304, and display change timer portion 305 are included.

The control portion 301 performs the processes of the initialization and the starting of the lap count portion 302, the remaining target time calculation portion 303, the split count portion 304, and the display change timer portion 305, the exchange of data with each portion or the like. The control portion 301 performs the processes of the data input and output with the input portion 202, the ROM 204, the RAM 205, the display portion 206, and the notification portion 207.

The command to start the timekeeping from the control portion 301 is input to the lap count portion 302, and the lap count portion 302 starts the timekeeping. In that case, the data under the measurement is erased (initialized), and the time data is counted up from 0. The command, which outputs the measured time (the lap elapsed time) from the control portion 301 to the control portion 301, is input to the lap count portion 302, whereby the lap count portion 302 outputs the lap elapsed time to the control portion 301. The command, which outputs the kept time (the lap elapsed time) from the control portion 301 to the remaining target time calculation portion 303, is input to the lap count portion 302, whereby the lap count portion 302 outputs the lap elapsed time to the remaining target time calculation portion 303.

The target time is input from the control portion 301 to the remaining target time calculation portion 303. The lap elapsed time is input from the lap count portion to the remaining target time calculation portion 303. The remaining target time calculation portion 303 calculates a value (the remaining target time) that subtracts the lap elapsed time from the target time. A command, which outputs the remaining target time to the control portion 301, is input from the control portion 301 to the remaining target time calculation portion 303. The remaining target time calculation portion 303 outputs the remaining target time to the control portion 301.

The command to start timekeeping is input from the control portion 301 to split count portion 304 to start the timekeeping. The command, which outputs the kept time (the split time) from the control portion 301 to the control portion 301, is input to the split count portion 304, and the split count portion 304 outputs the split time to the control portion 301.

When the lap elapsed time kept by the lap count portion 302 exceeds the target time, the display change timer portion 305 is started by the control portion 301 and starts the timekeeping of the display change time. The command, which outputs the display change time to the control portion 301, is input from the control portion 301 to the display change timer portion 305, whereby the display change timer portion 305 outputs the display change time to the control portion 301.

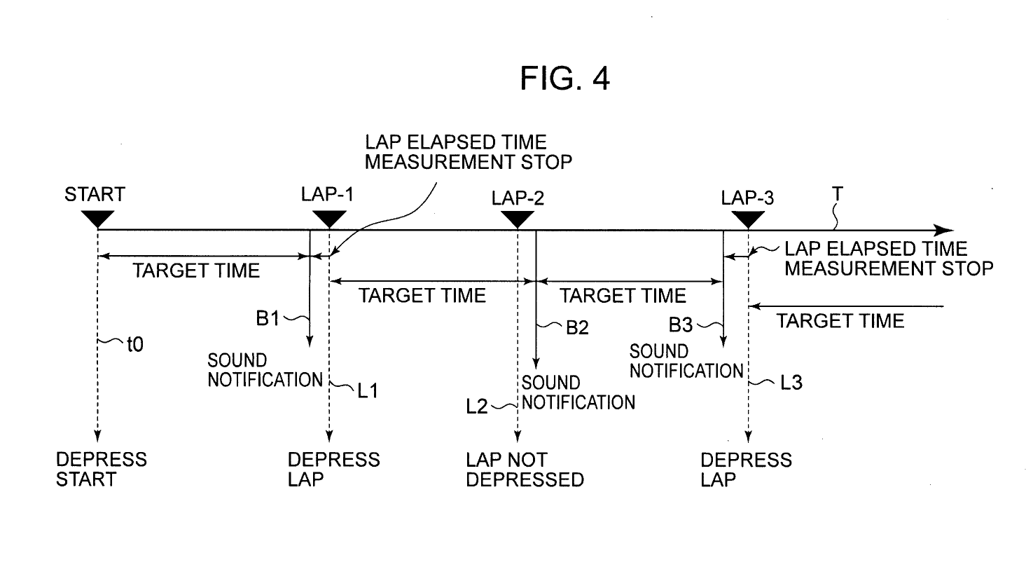

FIG. 4 is a diagram that shows an example of a relationship between the motion of the stopwatch 1 and the operation of a user in the present embodiment. T indicates a time axis and shows that the time proceeds rightward. A user presses the button 11 (the start) at a time t0 and starts the timekeeping. At this time, the control portion 301 starts the timekeeping of the split time by the use of the split count portion 304, and starts the timekeeping of the lap elapsed time by the use of the lap count portion 302. That is, the keeping of the split time and the keeping of the lap elapsed time are simultaneously started. The display portion 206 displays the current split time, the lap elapsed time, the remaining lap time or the like.

FIG. 4 shows a case where a user is unable to reach LAP-1, which is a 1 km point, within the target time. For that reason, before a user reaches LAP-1, the sound notification B1 is performed. At the same time, the control portion 301 initializes the lap count portion 302. The time data of the lap count portion 302 is counted up from 0 again. A user presses (L1) the button 12 (the lap point passage) when reaching LAP-1. As a result, the control portion 301 finishes the keeping of the lap elapsed time that is started when performing the sound notification (B1). Next, the control portion 301 initializes the lap count portion 302, and the time data is counted up from 0 again. In addition, the split count portion 304 continues the started timekeeping.

In the present example, a case is shown where a user does not press the button 12 when reaching a LAP-2. In this case, when a new lap elapsed time started in L1 is identical to the target time, that is, when the remaining target time is 0, the control portion 301 performs the sound notification (B2). At the same time, the control portion 301 initializes the lap count portion 302, and the time data of the lap count portion 302 is counted up from 0 again.

When a user reaches near a LAP-3, the lap elapsed time becomes identical to the target time again. That is, the remaining target time becomes 0. The control portion 301 outputs a command indicating that the sound notification is performed to the notification portion 207, and the sound notification portion 207 performs the sound notification (B3). When reaching the LAP-3, a user presses (L3) the button 12 (the lap point passage). As a result, the control portion 301 finishes the keeping of the lap elapsed time that is started when performing the sound notification B3. Next, the control portion 301 initializes the lap count portion 302, and the time data is counted up from 0 again.

In this manner, in the present embodiment, when reaching the LAP-2, even if the button 12 (the lap point passage) is not depressed, the target time elapses simultaneously, and the stopwatch 1 performs the sound notification (B2) and starts the measurement of a new lap elapsed time, whereby the stopwatch 1 performs the sound notification whenever the target time elapses until the button 12 is pressed.

Next, an example of the motion of the stopwatch 1 (the timepiece device) in the present embodiment will be described.

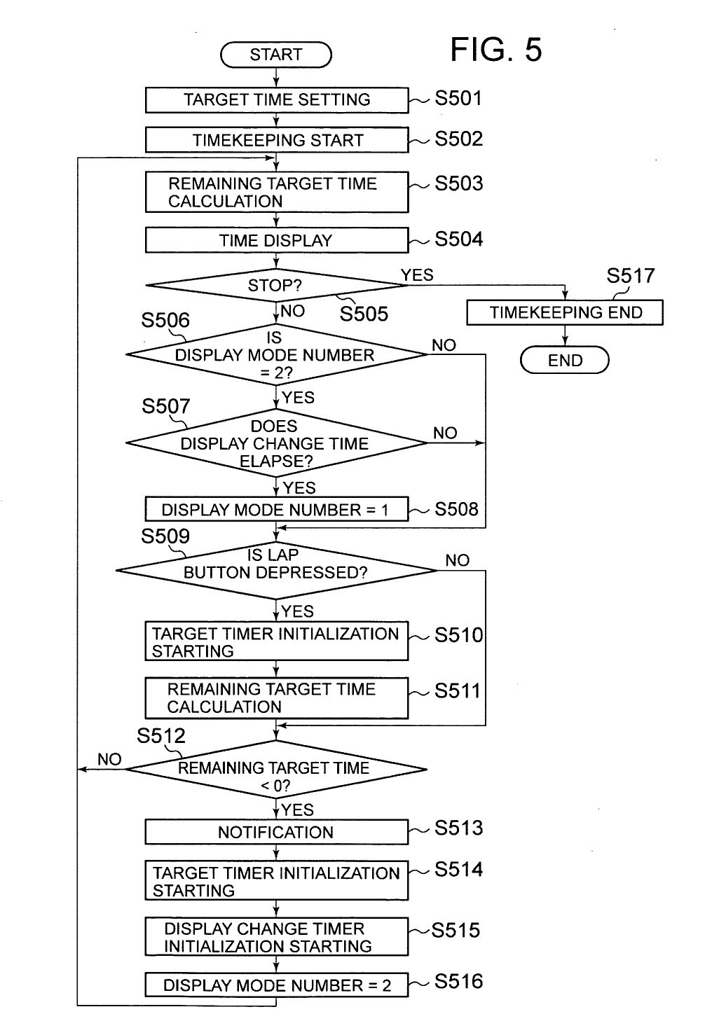

FIG. 5 is a flowchart that shows an example of the motion in the stopwatch 1 according to the present embodiment.

(Step S501) The target time is input from a user to the input portion 202 by the use of the buttons 11 to 14. The input portion 202 outputs the input target time to the control portion 301. The control portion 301 writes the target time, which is input from the input portion 202, onto the RAM 205. In addition, the target time may be common to each lap, and the different values may be set for each lap. After that, the process proceeds to step S502.

(Step S502) When the button 11 (the start) is depressed from a user, the input portion 202 outputs the signal indicating that the timekeeping is started to the control portion 301. The signal indicating that the timekeeping is started is input from the input portion 202 to the control portion 301, and the control portion 301 initializes the times of the split count portion 304 and the lap count portion 302 to zero.

The control portion 301 outputs a command, which starts the timekeeping, to the split count portion 304 and the lap count portion 302. The command, which starts the timekeeping, is input from the control portion 301 to the split count portion 304 and the lap count portion 302, thereby performing the timekeeping.

The control portion 301 writes 1 on the display mode number that is a number attached to each display pattern of information of the time which is displayed on the display portion 206, to the RAM 205. The display mode number will be described below in step S502. After that, the process proceeds to step S503.

(Step S503) The control portion 301 reads the target time from the RAM 205. The control portion 301 outputs the target time, which is read from the RAM 205, to the remaining target time calculation portion 303.

The control portion 301 outputs the command which outputs the lap elapsed time to the lap count portion 302. The command, which outputs the lap elapsed time, is input from the control portion 301 to the lap count portion 302, and the lap count portion 302 outputs the lap elapsed time to the remaining target time calculation portion 303.

The remaining target time calculation portion 303 calculates the remaining target time based on the target time and the lap elapsed time, and outputs the remaining target time to the control portion 301. After that, the process proceeds to step S504.

(Step S504) The control portion 301 outputs the remaining target time, which is input from the remaining target time calculation portion 303, to the display portion 206.

The control portion 301 outputs the command which outputs the split time to the split count portion 304. The command, which outputs the split time, is input from the control portion 301 to the split count portion 304, and the split count portion 304 outputs the split time to the control portion 301. The control portion 301 reads the display mode number from the RAM 205. The control portion 301 outputs the split time, which is input from the split count portion 304, to the display portion 206.

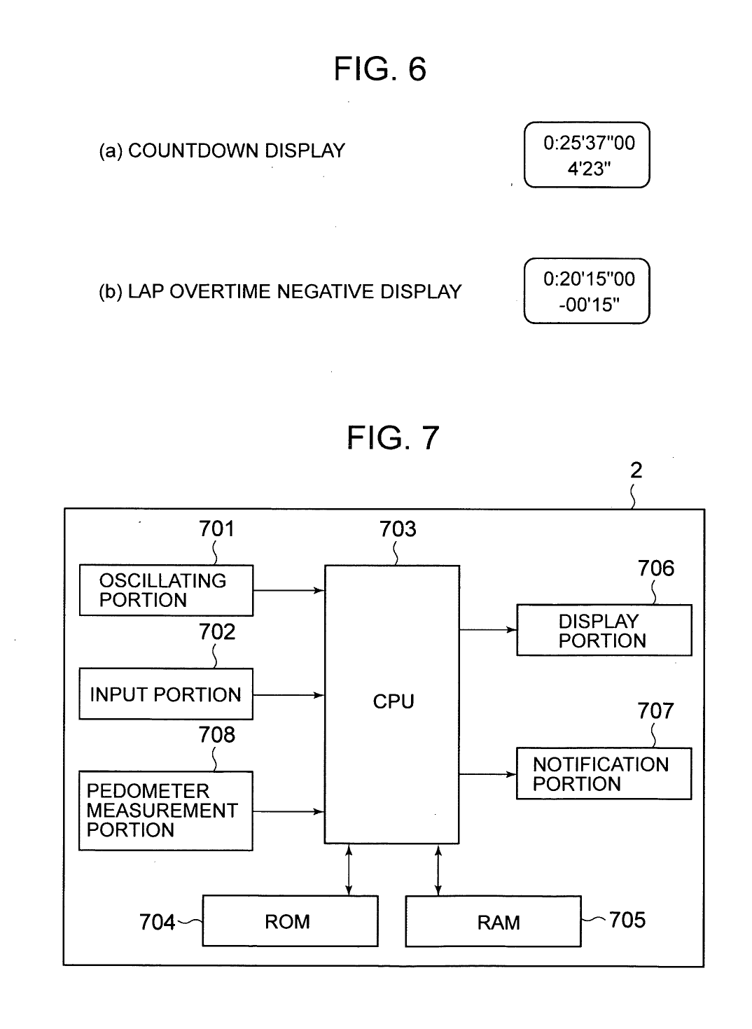

The control portion 301 outputs the display mode number, which is read from the RAM 205, to the display portion 206. The display portion 206 selects the display mode from the display mode number (1 or 2) which is input from the control portion 301. The display mode will be described below using FIG. 6, but, the split time and the remaining target time are simultaneously displayed in the display mode corresponding to the display mode number 1, and the split time and a lap overtime are simultaneously displayed in the display mode corresponding to the display mode number 2. Herein, the lap overtime is a time when the lap elapsed time exceeds the target time. This is identical to the lap elapsed time then newly kept when the lap elapsed time passes the target time and the time of the lap count portion 302 is initialized to 0. Depending on the display mode, the split time, the remaining target time, the lap overtime or the like are displayed. After that, the process proceeds to step S505.

(Step S505) The control portion 301 outputs the signal indicating a request for information whether or not the button 11 (the stop) is depressed to the input portion 202. The input portion 202 outputs information whether or not the button 11 is depressed to the control portion 301. The control portion 301 determines whether or not the timekeeping is finished based on the input from the input portion 202. When it is determined that the timekeeping is finished (Yes), the process proceeds to step S517, and it is determined that the timekeeping is not finished (No), the process proceeds to step S506.

(Step S506) The control portion 301 reads the display mode number from the RAM 205. The control portion 301 determines whether or not the display mode number is 2. When it is determined that the display mode number is 2 (Yes), the process proceeds to step S507, and when it is determined that the display mode number is not 2, the process proceeds to step S509.

(Step S507) The control portion 301 outputs the command, which outputs the display change time to the control portion 301, to the display change timer portion 305. The command, which outputs the display change time to the control portion 301, is input from the control portion 301 to the display change timer portion 305, and the display change timer portion 305 outputs the display change time to the control portion 301.

The control portion 301 determines whether or not the display is changed based on the input of the display change time form the display change timer portion 305, for example, based on whether or not the display determination time exceeds 10% of the target time. When it is determined that the display is changed (Yes), the process proceeds to step S508, and when it is determined that the display is not changed (No), the process proceeds to step S509. In addition, the standard of the determination may be changed when the display change time exceeds 30% of the target time or the like.

(Step S508) The control portion 301 rewrites the value of the display mode number stored in the RAM 205 to 1. After that, the process proceeds to step S509.

(Step S509) The control portion 301 outputs the signal indicating a request for information, whether or not the button 12 (the lap point passage) is depressed, to the input portion 202. The signal indicating a request for information whether or not the button 12 is depressed is input from the control portion 301 to the input portion 202, and the input portion 202 outputs information, whether or not the button 12 is depressed, to the control portion 301.

The control portion 301 determines whether or not the lap point is passed based on the input from the input portion 202. When it is determined that the lap point is passed, the process proceeds to step S510. When it is not determined that the lap point is passed, the process proceeds to step S512.

(Step S510) The control portion 301 outputs the command which stops the timekeeping to the lap count portion 302. The command, which stops the timekeeping from the control portion 301, is input to the lap count portion 302, and the lap count portion 302 stops the timekeeping. The control portion 301 initializes the time of the lap count portion 302 to 0. The control portion 301 outputs the command to start the timekeeping to the lap count portion 302. The command to start the timekeeping is input from the control portion 301 to the lap count portion 302, and the lap count portion 302 starts the timekeeping. After that, the process proceeds to step S511.

(Step S511) The control portion 301 reads the target time from the RAM 205. The control portion 301 outputs the target time read from the RAM 205 to the remaining target time calculation portion. The control portion 301 the lap elapsed time, which is output from the lap count portion 302, to the remaining target time calculation portion 303. The remaining target time calculation portion 303 calculates the remaining target time including the target time and the lap elapsed time, and outputs the remaining target time to the control portion 301. After that, the process proceeds to step S512.

(Step S512) The control portion 301 determines whether or not the remaining target time calculated by the remaining target time calculation portion 303 is less than 0. When it is determined that the remaining target time is less than 0 (Yes), the process proceeds to step S513. When it is determined that the remaining target time is equal to or greater than 0 (No), the process proceeds to step S503.

(Step S513) The control portion 301 outputs the command, which perform the notification indicating that the target time has elapsed, to the notification portion 207. The command, which performs the notification indicating that the target time has elapsed, is input from the remaining target time calculation portion 303 to the notification portion 207, and the notification portion 207 performs the notification indicating that the target time has elapsed to a user through the sound notification. In addition, the notification is performed through the sound notification, but a method such as a vibration can also be used. After that, the process proceeds to step S514.

(Step S514) The control portion 301 outputs the command to stop the timekeeping to the lap count portion 302. The command to stop the timekeeping is input from the control portion 301 to the lap count portion 302, and the lap count portion 302 stops the timekeeping. The control portion 301 initializes the time of the lap count portion 302 to 0.

The control portion 301 outputs the command to start the timekeeping to the lap count portion 302. The command to start the timekeeping is input from the control portion 301 to the lap count portion 302, and the lap count portion 302 starts the timekeeping. After that, the process proceeds to step S515.

(Step S515) The control portion 301 initializes the time of the display change timer portion 305 to 0. The control portion 301 outputs the command for starting the keeping of the display change time to the display change timer portion 305. The command to start the keeping of the display change time is input from the control portion 301 to the display change timer portion 305, and the display change timer portion 305 starts the timekeeping of the display change time. After that, the process proceeds to step S516.

(Step S516) The control portion 301 writes 2 on the display mode number preserved in the RAM 205. After that, the process proceeds to step S503.

(Step S517) The control portion 301 outputs the command to stop the timekeeping to the split count portion 304. The command to stop the timekeeping is input from the control portion 301 to the split count portion 304, and the split count portion 304 stops the timekeeping. The control portion 301 outputs the command to stop the timekeeping to the lap count portion 302. The command to stop the timekeeping is input from the control portion 301 to the lap count portion 302, whereby the lap count portion 302 stops the timekeeping.

FIG. 6 is a diagram that shows an example of the display in the display portion 206. A display (a) is an example in which a split time is displayed in an upper stage thereof and a remaining target time is displayed in a lower stage thereof (a display mode number 1). A display (b) is an example in which the split time is displayed on an upper stage thereof, and the lap elapsed time is displayed on a lower stage thereof with ‘−’ (negative) being added before the lap overtime. Generally, the display (a) is selected, and it is possible to know the object arrival time up to the next lap point. When the lap button is not depressed and the target time elapses, the display (b) is selected for a certain time, and it is possible to know delay time from the target time. After the certain time is finished, the display (a) is selected again, and it is possible to know the object arrival time up to the next lap point.

In this manner, according to the present embodiment, when the lap elapsed time measured by the lap count portion 302 passes a predetermined target time, and when a user presses the lap button, the stopwatch 1 is configured so that the lap count portion 302 sets the time to 0 to restart the measurement of the lap elapsed time. As a result, a user can start a new lap measurement even when failing to press the lap button.

Furthermore, according to the present embodiment, the indication when the lap elapsed time passes the target time is notified. As a result, a user is notified when the lap elapsed time passes the target tine.

Furthermore, according to the present embodiment, based on the lap elapsed time and the target time, the elapsed time is displayed from the finish of the previous target time when the lap elapsed time passes the target time, and the remaining target time is displayed when the lap button is depressed from a user. As a result, when passing the target time, a user can know by how long the time is delayed from a predetermined time, and when the lap button is depressed, a user can know the remaining target time.

Furthermore, according to the present embodiment, when the lap elapsed time passes the target time, the elapsed time from the target time is displayed, and after the passage of the display change time, the remaining target time is displayed. As a result, a user can know by how long a certain time after the passage of the target time is delayed from the predetermined time, and then, the time is automatically changed to the remaining target time display, whereby the remaining target time can be known.

### Second Embodiment

Hereinafter, a second embodiment of the present embodiment will be described with reference to the drawings. Since a stopwatch (referred to as a stopwatch 2) of the present embodiment has the same exterior of the stopwatch 1 of the first embodiment, the description thereof will be omitted.

FIG. 7 is a schematic block diagram that shows a configuration of a stopwatch 2 of the present embodiment. The schematic block diagram showing the configuration of the stopwatch 2 of the present embodiment is identical to that of FIG. 2 except that a pedometer measurement portion 708 is newly added. Thus, the description other than the pedometer measurement portion 708 will be omitted.

The pedometer measurement portion 708 detects a walking motion and measures the number of steps, based on the signal that is output from an accelerator sensor. A command to start the measurement of the number of steps is input from the CPU 703 into the pedometer measurement portion 708, and the pedometer measurement portion 708 starts the measurement of the number of steps. A command to output the number of steps measured from the CPU 703 to the CPU 703 is input to the pedometer measurement portion 708, and the pedometer measurement portion 708 outputs the measured number of steps.

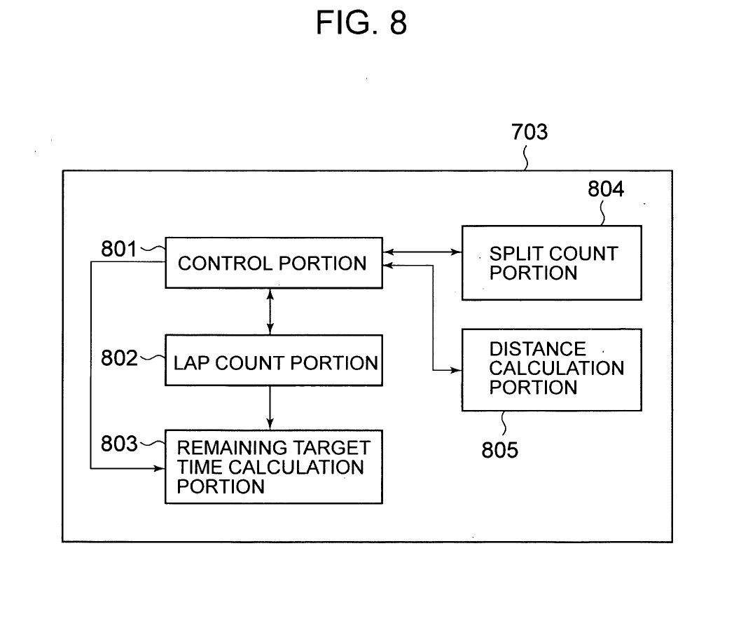

FIG. 8 is a schematic block diagram that shows configurations of each portion that performs the processing in the inner portion of the CPU 703. The schematic block diagram, which shows the configurations of each portion performing the processing in the inner portion of the CPU 703 of the present embodiment, is identical to that of FIG. 3 except that a distance calculation portion 805 is newly added. Thus, the description other than the distance calculation portion 805 will be omitted.

The number of steps, which is measured and output by the pedometer measurement portion 708, is input from the control portion 801 to the distance calculation portion 805. The distance calculation portion 805 calculates a value (a running distance) which multiplies the measured number of steps by a predetermined stride per step (for example, 0.7 m). The distance calculation portion 805 outputs the running distance to the control portion 801. In addition, the predetermined stride per step may be changed for each user.

Next, an example of the motion of the stopwatch 2 (a timepiece device) in the present embodiment will be described.

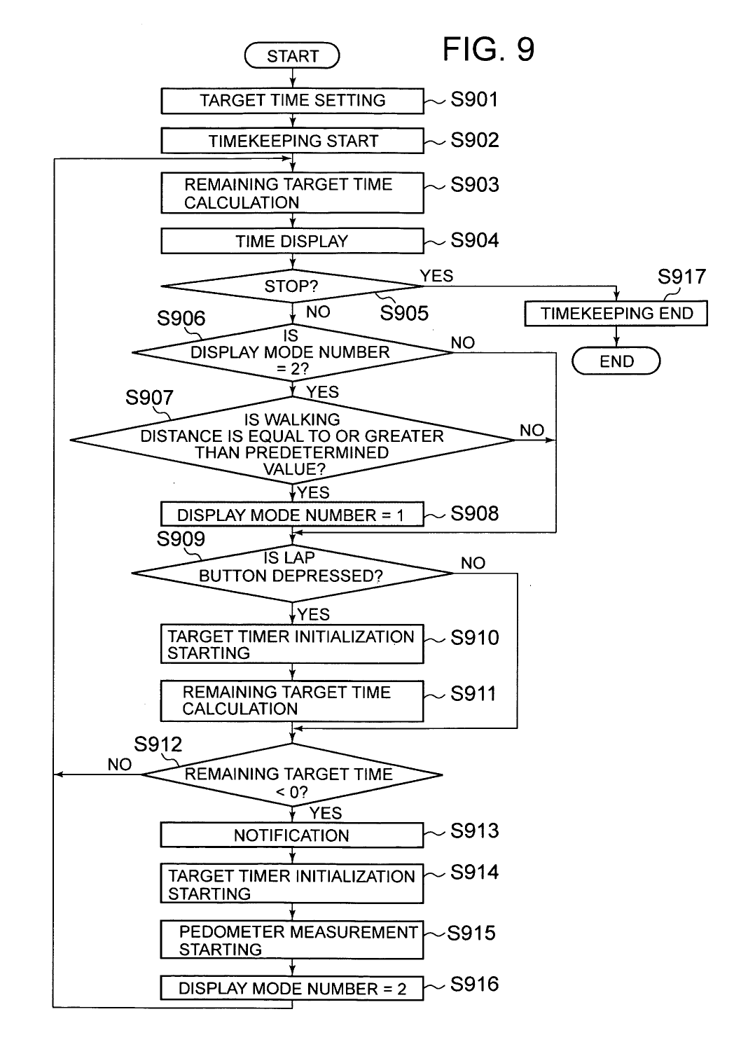

FIG. 9 is a flowchart that shows an example of the motion in the stopwatch 2 according to the present embodiment. In addition, since the respective processes of step S901 to step S906, step S908 to step S914, step S916 and S917 are basically identical to the respective processes of step S501 to S506, step S508 to step S514, step S516 and step S517 of the first embodiment (FIG. 5), respectively, the descriptions thereof will be omitted. However, the present embodiment is different from the first embodiment (FIG. 5) in that, when the result of the determination in step S906 is (Yes), the process proceeds to step S907, and the process proceeds to step S915 after the step S914.

(Step S907) The control portion 801 outputs a command to output the running distance to the control portion 801 to the distance calculation portion 805. The command to output the running distance is input from the control portion 801 to the distance calculation portion 805, and the distance calculation portion 805 calculates and outputs the running distance to the control portion 801.

The control portion 801 determines whether or not the display is changed, based on the input of information whether or not the walking distance from the distance calculation portion 805 is equal to or greater than a predetermined value. The determination is performed, for example, so that, the display is not changed when the running distance exceeds 100 m, and the display is not changed when the running distance does not exceed 100 m. When it is determined that the display is changed (Yes), the process proceeds to step S908, and when it is determined that the display is not changed (No), the process proceeds to step S909.

(Step S915) The control portion 801 initializes the running distance of the distance calculation portion 805 to 0. The control portion 801 outputs the command to start the measurement of the running distance to the distance calculation portion 805. The command to start the measurement of the running distance is input from the control portion 801 to the distance calculation portion 805, and the distance calculation portion 805 starts the measurement of the running distance. After that, the process proceeds to step S916.

In this manner, according to the present embodiment, the stopwatch 2 displays the delay of the target time until reaching a certain running distance after the target time elapses. After reaching a certain running distance, the display returns to the display of the remaining target time. As a result, a user can know by how long the time is delayed from a scheduled time until advancing for a certain distance after the target time elapses, and then, the display is automatically changed to the remaining target time display, whereby a user can know the remaining target time.

In addition, the stopwatch of the present embodiment may also have a pedometer function.

In addition, the program for realizing the functions is recorded on a computer-readable recording medium and the program recorded on the recording medium is read and executed by a computer system, whereby all or a part of functions of each portion included in the stopwatch in the embodiments mentioned above may be realized. In addition, “the computer system” mentioned herein includes an OS and hardware, such as peripheral devices.

Furthermore, “the computer-readable recording medium” refers to a portable medium such as a flexible disk, an optical magnetic disc, a ROM, and a CD-ROM, and a storage unit such as a hard disk equipped in the computer system. Furthermore, “the computer-readable recording medium” may include a medium which dynamically holds the program for a short period, such as a communication line of a case of transmitting the program via a network such as the Internet or a communication line such as a phone line, and a medium which holds the program for a certain time, such as a volatile memory in the inner portion of the computer system becoming a server or a client of that case. Furthermore, the program may be a program for realizing a part of the functions mentioned above, and may be program in which the functions mentioned above can be realized by the combination with the program recorded in the computer system in advance.

The embodiments of the present invention were described in detail with reference to the drawings, but the specific configuration is not limited to those mentioned above, and various design changes or the like can be made within the scope not departing from the gist of the present invention.

What is claimed is:

1. A timepiece device comprising:
a time measurement portion which measures a time,
wherein, when a measured time passes a predetermined target time, and when information indicating that there is an input from a user is input, the time measurement portion sets the time to zero and restarts the measurement of the time.

2. The timepiece device according to claim 1,
wherein the time measurement portion includes a control portion that performs a control of notifying a user that the measured time has passed the target time.

3. The timepiece device according to claim 2,
wherein the control portion performs a control which notifies elapsed time information that indicates a time measured from the elapsed time when the measured time has passed the target time, and a control which notifies a user of remaining time information indicating that the time measured from the time when information is input has passed the target time indicates a remaining time until passing the target time, when information indicating that there is an input from a user is input.

4. The timepiece device according to claim 3,
wherein, when the measured time has passed the target time and passes the predetermined time, the control portion displays the remaining time information.

5. The timepiece device according to claim 3,
wherein, when the measured time has passed the target time and a running distance measured by a pedometer measurement portion reaches a predetermined distance, the control portion displays the remaining time information.

6. An electronic apparatus that includes the timepiece device according to claim 1.

7. An electronic apparatus that includes the timepiece device according to claim 2.

8. An electronic apparatus that includes the timepiece device according to claim 3.

9. An electronic apparatus that includes the timepiece device according to claim 4.

10. An electronic apparatus that includes the timepiece device according to claim 5.

11. A pedometer that includes the timepiece device according to claim 1.

12. A pedometer that includes the timepiece device according to claim 2.

13. A pedometer that includes the timepiece device according to claim 3.

14. A pedometer that includes the timepiece device according to claim 4.

15. A pedometer that includes the timepiece device according to claim 5.

16. A program for causing a computer of a timepiece device to execute a sequence of setting a time to zero and starting the measurement of time when a measured time passes a predetermined target time and when information indicating that there is an input from a user is input.
